(19) United States
(12) Patent Application Publication
(10) Pub. No.: US 2025/0319829 A1
(43) Pub. Date: Oct. 16, 2025

(54) GROMMET AND VEHICLE INCLUDING THE SAME

(71) Applicants: HYUNDAI MOTOR COMPANY, Seoul (KR); KIA CORPORATION, Seoul (KR); KYUNGSHIN CO.,LTD., Incheon (KR)

(72) Inventors: Seungmin Kim, Hwaseong-si (KR); Byoungcheol Jeong, Hwaseong-si (KR); Boram Yu, Hwaseong-si (KR)

(73) Assignees: HYUNDAI MOTOR COMPANY, Seoul (KR); KIA CORPORATION, Seoul (KR); KYUNGSHIN CO.,LTD., Incheon (KR)

(21) Appl. No.: 18/926,021

(22) Filed: Oct. 24, 2024

(30) Foreign Application Priority Data
Apr. 12, 2024 (KR) 10-2024-0049428

(51) Int. Cl. B60R 16/02; H01B 17/58; H02G 3/04; H02G 3/40

(52) U.S. Cl. CPC B60R 16/0222; H01B 17/583; H02G 3/0406; H02G 3/0481; H02G 3/40

(57) ABSTRACT

A grommet may include a hollow body part configured to be penetrated by a wire, a first mounting part formed at one end of the body part, a second mounting part formed at the other end of the body part, a deformable part configured to connect the first mounting part and the second mounting part and configured to allow deformation of the body part, and at least one length adjustment part formed on the body part and configured to allow a change in length of the body part.

### CROSS REFERENCE TO RELATED APPLICATIONS

This application claims priority to and the benefit of Korean Patent Application No. 10-2024-0049428 filed in the Korean Intellectual Property Office on Apr. 12, 2024, the entire contents of which are incorporated herein by reference.

### BACKGROUND

### (a) Field

The disclosure relates to a grommet and a vehicle including the same, and more particularly, to a grommet, which is capable of being applied to various types of vehicles, and a vehicle including the same.

### (b) Description of the Related Art

In general, various electrical components are installed in a vehicle, and the electrical components are electrically connected by means of wires.

The wires may be installed while passing through a panel, a door, or the like in the vehicle. In this case, matching holes, through which the wires may pass, are formed in the panel or the door. A grommet is installed in the matching hole to protect and seal the wire.

In the related art, grommets are newly developed and applied to vehicles in consideration of layouts (e.g., an opening degree of a door with respect to a vehicle body, a position of a matching hole, or the like) of the vehicles.

However, in case that the grommet is newly developed and applied each time the layout of the vehicle is changed, there occurs a problem in that investment costs for the vehicle and product development costs are increased.

The above information disclosed in this background section is only for enhancement of understanding of the background of the disclosure and therefore it may contain information that does not form the prior art that is already known in this country to a person of ordinary skill in the art.

### SUMMARY

The present disclosure attempts to provide a grommet, which is capable of being applied to various layouts of vehicles, and a vehicle including the same.

A grommet according to an embodiment may include a hollow body part configured to be penetrated by a wire, a first mounting part formed at one end of the body part; a second mounting part formed at the other end of the body part, a deformable part configured to connect the first mounting part and the second mounting part and configured to allow deformation of the body part, and at least one length adjustment part formed on the body part and configured to allow a change in length of the body part.

In several embodiments, the deformable part may be formed in a bellows shape.

In several embodiments, the length adjustment part may include a variable part configured to be adjusted in length by an external force, and a fixing unit configured to fix the variable part with the adjusted length.

In several embodiments, the variable part may be formed in a bellows shape.

In several embodiments, the fixing unit may include a first fixing protrusion formed at one side of the variable part, and a strap configured to be selectively coupled to the first fixing protrusion to fix a length of the variable part.

In several embodiments, a plurality of first fixing holes may be formed in the strap and separably coupled to the first fixing protrusion.

In several embodiments, the fixing unit may further include a second fixing protrusion formed at the other side of the variable part and separably coupled to the strap.

In several embodiments, a second fixing hole may be formed in the strap and separably coupled to the second fixing protrusion.

In several embodiments, the strap may extend from an end of the deformable part.

In several embodiments, the length adjustment parts may be respectively formed at two opposite sides of the deformable part.

A vehicle according to another embodiment may include a first mounting part configured to be fixed to any one of a vehicle body and a door, a second mounting part configured to be fixed to the other of the vehicle body and the door, a hollow body part configured to connect the first mounting part and the second mounting part and be penetrated by a wire, a deformable part configured to allow deformation of the body part, and a length adjustment part configured to allow a change in length of the body part.

In several embodiments, the deformable part may be formed in a bellows shape.

In several embodiments, the length adjustment part may include a variable part configured to be adjusted in length by an external force, a first fixing protrusion formed at one side of the variable part, a second fixing protrusion formed at the other side of the variable part, and a strap having a plurality of first fixing holes separably coupled to the first fixing protrusion, and a second fixing hole separably coupled to the second fixing protrusion.

In several embodiments, the plurality of first fixing holes may be formed in a longitudinal direction of the variable part.

In several embodiments, the first fixing hole may be formed in a distal portion of a portion of the body part to which the strap is fixed, and the second fixing hole may be formed in a proximal portion of the portion of the body part to which the strap is fixed.

In several embodiments, the first fixing protrusion may be formed on the distal portion of the portion of the body part to which the strap is fixed, and the second fixing protrusion may be formed on the proximal portion of the portion of the body part to which the strap is fixed.

In several embodiments, the length adjustment parts may be respectively formed at two opposite sides of the deformable part.

According to the embodiment, the length of the variable part of the grommet is adjusted, and the variable part with the adjusted length is fixed by the fixing protrusion and the fixing hole of the strap, such that the grommet according to the embodiment may be applied to various types of vehicles.

In addition, because the grommet may be applied to various types of vehicles, it is not necessary to separately manufacture new grommets depending on the types of vehicles, which may reduce separate material costs and mold costs.

In addition, because the strap is fixedly installed on a part of the body, the rigidity of the body of the grommet may be reinforced at the same time when the length of the body of the grommet is adjusted.

Other effects, which may be obtained or expected by the embodiments of the present disclosure, will be directly or implicitly disclosed in the detailed description of the present disclosure. That is, various effects expected according to the present disclosure will be disclosed in the detailed description to be described below.

### BRIEF DESCRIPTION OF THE FIGURES

Because the drawings are provided for reference to describe exemplary embodiments of the present disclosure, the technical spirit of the present disclosure should not be construed as being limited to the accompanying drawings.

FIGS. 1 and 2 are perspective views illustrating a configuration of a grommet according to an embodiment.

FIGS. 3 and 4 are perspective views illustrating a configuration of a grommet according to another embodiment.

FIG. 5A is a cross-sectional view illustrating a state in which a fixing protrusion and a strap according to the embodiment are separated.

FIG. 5B is a cross-sectional view illustrating a state in which the fixing protrusion and the strap according to the embodiment are coupled.

FIG. 6 is a view illustrating a state in which a length of a variable part of the grommet according to the embodiment is increased.

FIG. 7 is a view illustrating a state in which a length of the variable part of the grommet according to the embodiment is decreased.

It should be understood that the accompanying drawings are not necessarily to scale, but provide a somewhat simplified representation of various preferred features that exemplify the basic principles of the present disclosure. For example, specific design features of the present disclosure, including particular dimensions, directions, positions, and shapes, will be partially determined by the particularly intended application and use environment.

### DETAILED DESCRIPTION

The terms used herein are merely for the purpose of describing a specific embodiment, and not intended to limit the present disclosure. The singular expressions used herein are intended to include the plural expressions unless the context clearly dictates otherwise. It is to be understood that the term “comprise (include)” and/or “comprising (including)” used in the present specification means that the features, the integers, the steps, the operations, the constituent elements, and/or component are present, but the presence or addition of one or more of other features, integers, steps, operations, constituent elements, components, and/or groups thereof is not excluded. The term “and/or” used herein includes any one or all the combinations of listed related items.

The present disclosure will be described in detail with reference to the accompanying drawings so that those with ordinary skill in the art to which the present disclosure pertains may easily carry out the embodiments. However, the present disclosure may be implemented in various different ways and is not limited to the embodiments described herein.

A part irrelevant to the description will be omitted to clearly describe the present disclosure, and the same or similar constituent elements will be designated by the same reference numerals throughout the specification.

In addition, the size and thickness of each component illustrated in the drawings are arbitrarily shown for ease of description, but the present disclosure is not limited thereto. In order to clearly describe several portions and regions, thicknesses thereof are enlarged.

The suffixes ‘module’, ‘unit’, ‘part’, and/or ‘portion’ used to describe constituent elements in the following description are used together or interchangeably in order to facilitate the description, but the suffixes themselves do not have distinguishable meanings or functions.

In addition, in the description of the disclosed embodiment, the specific descriptions of publicly known related technologies will be omitted when it is determined that the specific descriptions may obscure the subject matter of the embodiment disclosed in the present specification.

In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms.

In the following description, the singular expression “one” or “single” may be interpreted as the singular or plural expression unless explicitly stated.

These terms are used only to distinguish one constituent element from another constituent element.

Hereinafter, a grommet according to an embodiment will be described in detail with reference to the accompanying drawings.

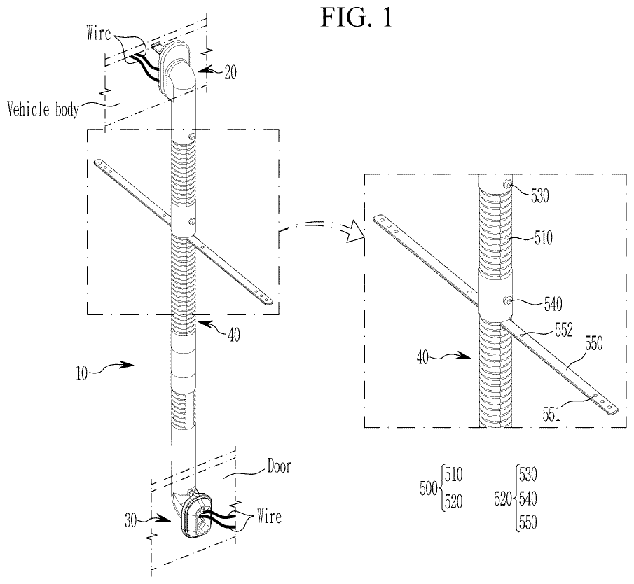

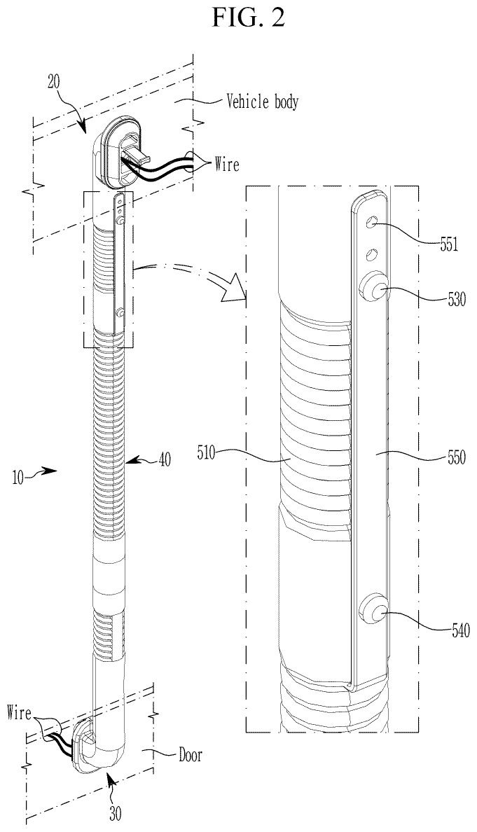

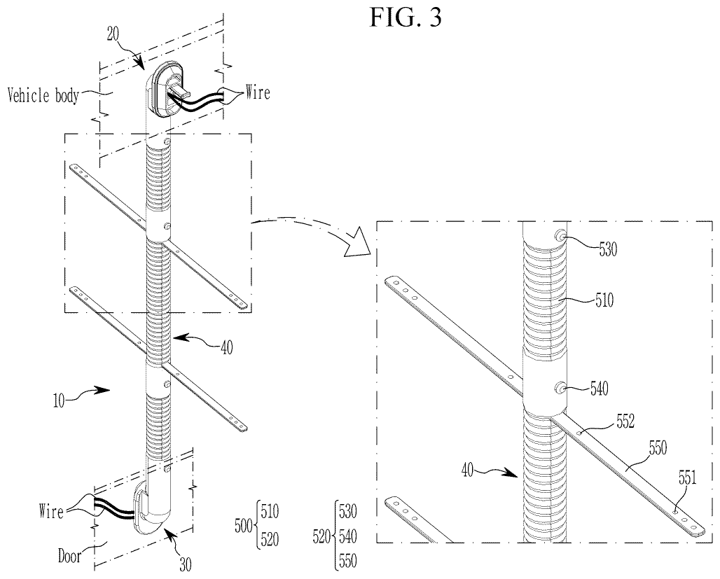

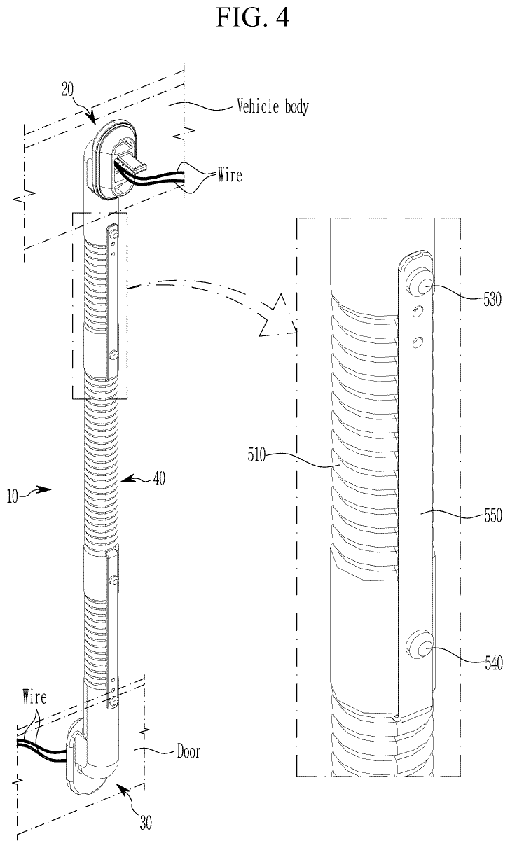

FIGS. 1 and 2 are perspective views illustrating a configuration of a grommet according to an embodiment. Further, FIGS. 3 and 4 are perspective views illustrating a configuration of a grommet according to another embodiment.

As illustrated in FIGS. 1 to 4, the grommet according to the embodiment may include a hollow body part 10, a first and second mounting parts 20 and 30 formed on the body part 10, a deformable part 40 configured to allow deformation of the body part 10, and a length adjustment part 500 configured to allow a change in length of the body part 10.

The inside of the body part 10 may be entirely empty so that a wire penetrates the inside of the body part 10. For example, a channel may be formed in the body part 10 so that the wire may penetrate the body part 10. The body part 10 may be formed in an approximately cylindrical shape.

The first mounting part 20 may be formed at one end of the body part 10 and fixed to a vehicle body of a vehicle. A center of the first mounting part 20 may be opened so that the wire, which penetrates the body part 10, may extend to the outside of the first mounting part 20.

The second mounting part 30 may be formed at the other end of the body part 10 and fixed to a door of the vehicle. A center of the second mounting part 30 may be opened so that the wire, which penetrates the body part 10, may extend to the outside of the second mounting part 30.

The deformable part 40 may be formed on an approximately middle portion of the body part 10 and formed in a bellows shape so that the body part 10 is allowed to be deformed by an external force.

The length adjustment part 500 may be configured to adjust an overall length of the grommet in accordance with a user's external force (or intention) and include a variable part 510 configured to be adjusted in length by an external force, and a fixing unit 520 configured to fix the variable part 510 with the adjusted length.

The variable part 510 may be formed in a bellows shape so that the length of the variable part 510 may be adjusted.

The fixing unit 520 may include a first fixing protrusion 530 formed at one side of the variable part 510, a second fixing protrusion 540 formed at the other side of the variable part 510, and a strap 550 configured to be selectively coupled to the first fixing protrusion 530 and the second fixing protrusion 540 to fix a length of the variable part 510.

The fixing unit 520 may be provided on at least any one side of the variable part 510. In the embodiment, the fixing units 520 may be provided at two opposite sides of the variable part 510. The fixing units 520 may be provided to face each other based on the variable part 510.

A first fixing hole 551, which is separably coupled to the first fixing protrusion 530, and a second fixing hole 552, which is separably coupled to the second fixing protrusion 540, may be formed in the strap 550 so that the strap 550 may be coupled to the first fixing protrusion 530 and the second fixing protrusion 540.

The strap 550 may extend from an end of the variable part 510. That is, one end of the strap 550 may be fixed to the end of the variable part 510, and the other end of the strap 550 may be configured as a free end. The strap 550 may be made of an elastically deformable material.

The first fixing protrusion 530 may be formed on a distal portion of a portion of the body part 10 to which the strap 550 is fixed, and the second fixing protrusion 540 may be formed on a proximal portion of the portion of the body part 10 to which the strap 550 is fixed.

That is, a first invariable part 510, which does not change in length, may be formed between the deformable part 40 and the variable part 510, and the first fixing protrusion 530 may be formed on the first invariable part 510. Further, a second invariable part 510, which does not change in length, may be formed between the variable part 510 and the first mounting part 20, and the second fixing protrusion 540 may be formed on the second invariable part 510.

The first fixing protrusion 530 and the second fixing protrusion 540 may be formed in the same shape. The first fixing protrusion 530 and the second fixing protrusion 540 may be formed in a plural along the longitudinal direction of the body part 10.

The fixing protrusions may each include a protrusion column 531, and a protrusion head 533 formed at an end of the protrusion column 531.

The protrusion column 531 may extend radially outward from an outer periphery of the body part 10 and be formed in an approximately cylindrical shape. A length of the protrusion column 531 may correspond to a thickness of the strap 550. For example, the length of the protrusion column 531 may be equal to the thickness of the strap 550.

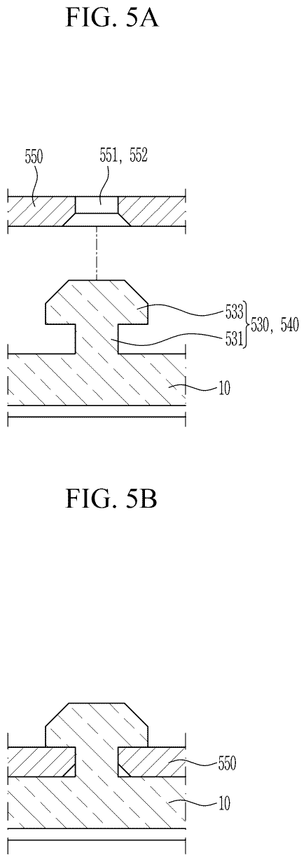

The protrusion head 533 may be formed at the end of the protrusion column 531 and formed in an approximately cylindrical shape. A diameter of the protrusion head 533 may be larger than a diameter of the protrusion column 531. A chamfer may be formed at an end of the protrusion head 533 (see FIGS. 5A and 5B). The protrusion head 533 may be smoothly inserted into the fixing hole formed in the strap 550 by the chamfer formed on the protrusion head 533.

In addition, the first fixing hole 551 formed in the strap 550 may be formed in the proximal portion of the portion of the body part 10 to which the strap 550 is fixed, and the second fixing hole 552 may be formed in the distal portion of the portion of the body part 10 to which the strap 550 is fixed.

The first fixing hole 551 may be formed at a position corresponding to the first fixing protrusion 530, and the second fixing hole 552 may be formed at a position corresponding to the second fixing protrusion 540 with the adjusted length.

That is, the first fixing hole 551 may be formed in the distal portion of the portion of the body part 10 to which the strap 550 is fixed, and the second fixing hole 552 may be formed in the proximal portion of the portion of the body part 10 to which the strap 550 is fixed.

The first fixing hole 551 may be provided as a plurality of first fixing holes 551 formed in the strap 550. The plurality of first fixing holes 551 may be sequentially formed in a longitudinal direction of the strap 550. In the embodiment, three first fixing holes 551 may be formed.

A chamfer may be formed at an edge of each of the fixing holes facing the body part 10 (see FIGS. 5A and 5B). The protrusion head 533 may be smoothly inserted into the fixing hole by the chamfer formed on the fixing hole and the chamfer formed on the protrusion head 533.

The length adjustment part 500 may be provided on at least any one side of the deformable part 40 of the body part 10.

As illustrated in FIGS. 1 and 2, the length adjustment part 500 may be provided only at one side of the deformable part 40 of the body part 10. In case that the length of the grommet does not need to be adjusted, the length adjustment part 500 may be provided only at one side of the deformable part 40. For example, in case that an opening angle of the door from the vehicle body is small (or an opening degree is small), the length adjustment part 500 may be provided only at one side of the deformable part 40.

Alternatively, as illustrated in FIGS. 3 and 4, the length adjustment parts 500 may be provided at two opposite sides of the deformable part 40 of the body part 10. The length adjustment parts 500 provided at the two opposite sides of the deformable part 40 may be formed to be symmetric. In case that the length of the grommet needs to be adjusted to a large degree, the length adjustment parts 500 may be provided at the two opposite sides of the deformable part 40. For example, in case that an opening angle of the door from the vehicle body is large (or an opening degree is large), the length adjustment parts 500 may be provided at the two opposite sides of the deformable part 40.

Hereinafter, a method of using the grommet according to the embodiment will be described in detail with reference to the accompanying drawings.

First, a user inserts the wire into the body of the grommet.

In consideration of a rotation angle of the door with respect to the vehicle body, the user appropriately adjusts the length of the variable part 510 of the length adjustment unit and inserts the first fixing protrusion 530, which is formed on the body, into any one of the plurality of first fixing holes 551 formed in the strap 550.

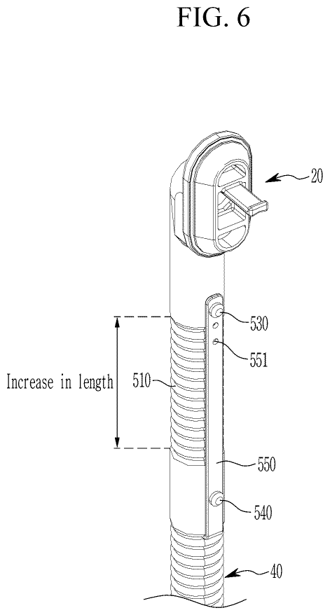

For example, in order to decrease the length of the variable part 510, the first fixing hole 551, which is adjacent to the portion of the body to which the strap 550 is fixed among the plurality of first fixing holes 551 formed in the strap 550, may be coupled to the first fixing protrusion 530 (see FIG. 6).

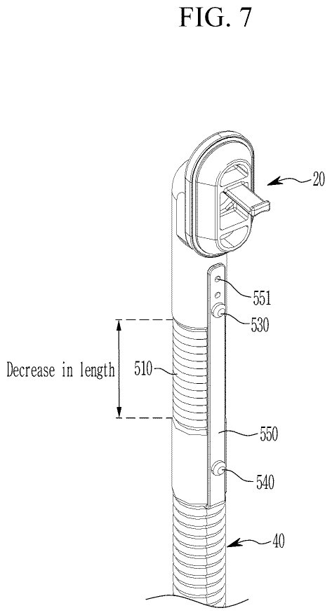

On the contrary, in order to increase the length of the variable part 510, the first fixing hole 551, which is distant from the portion of the body to which the strap 550 is fixed among the plurality of first fixing holes 551 formed in the strap 550, may be coupled to the first fixing protrusion 530 (see FIG. 7).

In this case, the first fixing protrusion 530 is inserted into the first fixing hole 551 in an interference-fit manner, such that the strap 550 may be prevented from being withdrawn from the first fixing protrusion 530. In addition, the protrusion head 533 of the first fixing protrusion 530 may be smoothly inserted into the first fixing hole 551 by the chamfer formed on the protrusion head 533 of the first fixing protrusion 530 and the chamfer formed on the first fixing hole 551.

Further, the user inserts the second fixing protrusion 540, which is formed on the body, into the second fixing hole 552 formed in the strap 550.

In this case, the second fixing protrusion 540 is inserted into the second fixing hole 552 in an interference-fit manner, such that the strap 550 may be prevented from being withdrawn from the second fixing protrusion 540. In addition, the protrusion head 533 of the second fixing protrusion 540 may be smoothly inserted into the second fixing hole 552 by the chamfer formed on the protrusion head 533 of the second fixing protrusion 540 and the chamfer formed on the second fixing hole 552.

The second fixing protrusion 540, which is formed on the body, is inserted into the second fixing hole 552 formed in the strap 550, such that the strap 550 may be prevented from being separated from the body.

Thereafter, the first mounting part 20 may be mounted on the vehicle body of the vehicle, and the second mounting part 30 may be mounted on the door of the vehicle.

According to the grommet and the vehicle including the same according to the embodiment, the length of the variable part 510 of the grommet is adjusted, and the variable part 510 with the adjusted length is fixed by the fixing protrusion and the fixing hole of the strap 550, such that the grommet according to the embodiment may be applied to various types of vehicles.

In addition, because the grommet may be applied to various types of vehicles, it is not necessary to separately manufacture new grommets depending on the types of vehicles, which may reduce separate material costs and mold costs.

In addition, because the strap 550 is fixedly installed on a part of the body, the rigidity of the body of the grommet may be reinforced at the same time when the length of the body of the grommet is adjusted.

While the embodiments of the present disclosure have been described above, the present disclosure is not limited thereto, and various modifications can be made and carried out within the scope of the claims, the detailed description of the disclosure, and the accompanying drawings, and also fall within the scope of the present disclosure.

1. A grommet comprising:
a hollow body part configured to be penetrated by a wire;
a first mounting part formed at a first end of the body part;
a second mounting part formed at a second end of the body part;
a deformable part configured to connect the first mounting part and the second mounting part, and configured to allow deformation of the body part; and
at least one length adjustment part formed on the body part and configured to allow a change in length of the body part.

2. The grommet of claim 1, wherein the deformable part is formed in a bellows shape.

3. The grommet of claim 1, wherein the length adjustment part comprises:
a variable part configured to be adjusted in length by an external force; and
a fixing unit configured to fix the variable part with the adjusted length.

4. The grommet of claim 3, wherein the variable part is formed in a bellows shape.

5. The grommet of claim 3, wherein the fixing unit comprises:
a first fixing protrusion formed at one side of the variable part; and
a strap configured to be coupled to the first fixing protrusion to fix a length of the variable part.

6. The grommet of claim 5, wherein a plurality of first fixing holes are formed in the strap and separably coupled to the first fixing protrusion.

7. The grommet of claim 5, wherein the fixing unit further comprises:
a second fixing protrusion formed at an other side of the variable part and separably coupled to the strap.

8. The grommet of claim 7, wherein a second fixing hole is formed in the strap and separably coupled to the second fixing protrusion.

9. The grommet of claim 5, wherein the strap extends from an end of the deformable part.

10. The grommet of claim 1, wherein the at least one length adjustment part comprises at least two length adjustment parts each formed at an opposite side of the deformable part.

11. A vehicle comprising:
a first mounting part configured to be fixed to any one of a vehicle body and a door;
a second mounting part configured to be fixed to an other of the vehicle body and the door;
a hollow body part configured to connect the first mounting part and the second mounting part, and be penetrated by a wire;
a deformable part configured to allow deformation of the body part; and
a length adjustment part configured to allow a change in length of the body part.

12. The vehicle of claim 11, wherein the deformable part is formed in a bellows shape.

13. The vehicle of claim 11, wherein:
the length adjustment part comprises:
a variable part configured to be adjusted in length by an external force;
a first fixing protrusion formed at one side of the variable part;
a second fixing protrusion formed at an other side of the variable part; and
a strap having a plurality of first fixing holes separably coupled to the first fixing protrusion, and a second fixing hole separably coupled to the second fixing protrusion.

14. The vehicle of claim 13, wherein the plurality of first fixing holes are formed in a longitudinal direction of the variable part.

15. The vehicle of claim 13, wherein:
the plurality of first fixing holes are formed in a distal portion of a portion of the body part to which the strap is fixed; and
the second fixing hole is formed in a proximal portion of the portion of the body part to which the strap is fixed.

16. The vehicle of claim 15, wherein:
the first fixing protrusion is formed on the distal portion of the portion of the body part to which the strap is fixed; and
the second fixing protrusion is formed on the proximal portion of the portion of the body part to which the strap is fixed.

17. The vehicle of claim 12, wherein the length adjustment part comprises at least two length adjustment parts each formed at two opposite sides of the deformable part.
